(19) United States
(12) Patent Application Publication
(10) Pub. No.: US 2025/0077844 A1
(43) Pub. Date: Mar. 6, 2025

(54) SCALING UTILIZATION OF LARGE LANGUAGE MODELS

(71) Applicant: Microsoft Technology Licensing, LLC, Redmond, WA (US)

(72) Inventors: Jianzhe LIN, Bellevue, WA (US); Maurice DIESENDRUCK, Bellevue, WA (US); Manqing MAO, Kenmore, WA (US); Yijian XIANG, Redmond, WA (US); Julia T. CHEN, Bellevue, WA (US); Paishun TING, Kirkland, WA (US); Mingyang XU, Kenmore, WA (US); Liang DU, Redmond, WA (US); Robin ABRAHAM, Redmond, WA (US)

(21) Appl. No.: 18/534,299

(22) Filed: Dec. 8, 2023

Related U.S. Application Data
(60) Provisional application No. 63/579,730, filed on Aug. 30, 2023.

(51) Int. Cl. G06N 3/0455; G06N 3/0475

(52) U.S. Cl. CPC G06N 3/0455; G06N 3/0475

(57) ABSTRACT

The present disclosure relates to efficiently receiving and processing input tasks in a way that is scalable and which reduces both the quantity of tokens processed by a foundation model (e.g., an LLM) as well as the number of API calls that are made in processing the input tasks. A system batches a set of inputs to provide as a single batch of input(s) into an LLM. The system generates one or more permutations of the batched input(s) to determine outputs based on variable orders in which the input data is provided within the respective permutations of the batched inputs. The system further may eliminate one or more of the data inputs within the respective batches to facilitate smaller batched inputs without sacrificing accuracy in a set of outputs generated by the LLM responsive to the batch permutations.

### CROSS REFERENCE TO RELATED APPLICATIONS

This application claims benefit and priority to Provisional Application No. 63/579,730, filed on Aug. 30, 2023, the entirety of which is incorporated herein by reference.

### BACKGROUND

Recent years have seen significant increase in popularity and applications of artificial intelligence (AI) and machine learning (ML). In addition, with services hosted by cloud computing systems becoming increasingly available to end-users and other organizations, accessibility to more complex and robust computing models, such as large language models (LLMs) has become increasingly common. These foundation models can be trained to perform a wide variety of tasks, such as chat bots, providing answers to general questions, generating code and other programming script, and, in some cases, providing specific information about specific topics.

While foundation models, such as ChatGPT and other large language models provide useful tools in performing a variety of tasks using a significant pool of computing resources, there are significant computing and processing expenses related to training these large language models to accurately and quickly perform various tasks. Moreover, these LLMs often demand expensive state-of-the-art infrastructure (e.g., GPUs) to host. As these models expand, continue to scale upward, and increase the token budgets with which queries and context can be input into the LLMs, the cost associated with running applications that leverage these LLM resources can become inefficient and computationally expensive, particularly as more and more application programming interface (API) calls are made.

These and other problems exist in connection with utilizing and scaling LLM and other foundation model resources.

### BRIEF DESCRIPTION OF THE DRAWINGS

FIG. 1 illustrates an example environment including a batch prompt generation system in accordance with one or more embodiments.

FIGS. 2A-2C illustrate portions of an example workflow in which a batch prompt generation system generates a batch output set in response to a plurality of input prompts in accordance with one or more embodiments.

FIG. 3 illustrates an example workflow showing features of a batch prompt generation system in accordance with one or more embodiments.

FIG. 4 illustrates an example series of acts for extracting and classifying data from digital content items in accordance with one or more embodiments.

FIG. 5 illustrates certain components that may be included within a computer system.

### DETAILED DESCRIPTION

The present disclosure relates to systems, methods, and computer-readable media for efficiently receiving and processing input tasks in a way that is scalable and in a way which reduces both the quantity of tokens processed by a foundation model (e.g., an LLM) as well as the number of application programming interface (API) calls that are made in processing the input tasks. For example, as will be discussed in further detail below, a batch prompt generation system batches a set of inputs to provide as a single batch of input(s) into an LLM (or other foundation model). The batch prompt generation system additionally generates one or more permutations of the batched input(s) to determine outputs based on variable orders in which the input data is provided within the respective permutations of the batched inputs. In one or more embodiments, the batch prompt generation system further eliminates one or more of the data inputs within the respective batches to facilitate smaller batched inputs without sacrificing accuracy in a set of outputs generated by the LLM responsive to the batch permutations.

As an illustrative example, the batch prompt generation system may perform (or cause to perform) a series of acts for processing batches of inputs using one or more LLMs. In one or more embodiments, the batch prompt generation system generates a batch prompt including a task input and a plurality of data inputs associated with the task where the data inputs are in a particular order. The batch prompt generation system may also generate any number of batch permutations in which the data inputs from the first batch prompt are reordered (e.g., randomly). The batch prompt generation system may cause an LLM (or other foundation model) to be applied to the batch permutations (and the initial batch prompt) to generate sets of outputs for each of the batch prompts (and/or permutations). The batch prompt generation system may consider characteristics of the outputs (e.g., confidence values, consistency across batch prompts) to determine a set of outputs (e.g., final outputs) based on a combination of outputs associated with the respective batch prompts.

The present disclosure provides a number of practical applications that provide benefits and/or solve problems associated with applying LLMs and other foundation models to collections of input prompts, particularly where the input prompts relate to similar types of tasks. By way of example and not limitation, some of these features and corresponding benefits will be discussed in connection with some example problems and shortcoming of conventional LLM systems.

Many modern LLMs have token limits associated with a number of words or characters that an LLM is configured to process with respect to a query or series of queries. As LLMs have grown in size and complexity, token limits have increased, which allows for more complex queries to be processed; however, this also significantly increases the computational budgets that are expended in processing queries and associated prompts. Indeed, as LLMs have become more capable in processing larger queries including more robust contexts and larger inputs, token budgets are quickly expended and LLMs are often unable to provide adequate services in response to series of multiple queries associated with performing one or more related tasks.

In addition to failing to scale in complexity, conventional LLMs also inefficiently budget tokens when a series of related prompts are received. Indeed, in response to receiving a series of inputs associated with a particular task, many LLMs process each input and associated task individually, which causes a number of inefficiencies and inaccuracies. For example, processing individual input prompts including both a task and corresponding input can become quite inefficient when processing a large number of inputs that have similar types of tasks. Moreover, because conventional LLMs often provide outputs that consider both the inputs and the outputs and contexts of previous prompts, processing individual prompts individually can ultimately see less accurate responses over time.

As will be discussed in further detail herein, the batch prompt generation system batches input prompts in a manner that reduces the number of tokens expended in processing a series of related prompts. Indeed, by batching input prompts in accordance with one or more embodiments, reduces the number of tokens used as a result of removing multiple instances of a task statement (e.g., a task specification) in processing a series of related prompts.

The batch prompt generation system further prevents inaccuracy issues in a number of ways, such as by reordering data inputs from the batch prompt. For example, as will be discussed in further detail below, the batch prompt generation system generates multiple permutations of the batch prompt in which the data inputs are reordered. This reordering of the batch prompts provides enhanced accuracy by enabling the LLM to evaluate the data inputs in different orders and considering the context that the different orders provide in performing the task(s) with respect to each of the data inputs. By comparing the outputs from the different permutations, the batch prompt generation system facilitates higher accuracy in a fewer number of batches than would be performed in conventional systems.

In addition to utilizing tokens inefficiently and causing potential accuracy issues, conventional approaches to processing individual prompts also results in a large number of application programming interface (API) calls. This larger number of API calls not only expends considerable computational resources, but also bandwidth resources associated with devices and components interfacing with one another (e.g., over a network). By batching prompts in accordance with one or more embodiments described herein, the batch prompt generation system decreases the number of API calls performed by conventional systems when utilizing LLMs. In addition, as will be discussed below, the batch prompt generation system implements a process in which confident outputs are removed from subsequent batches, which further decreases the number of API calls (and tokens expended) without sacrificing accuracy in the outputs of the LLM(s).

In addition to the above features and associated benefits, it will be appreciated that recent progress in large language models (LLMs) has enabled the processing of long texts consisting of tens of thousands of tokens, which are sufficient for numerous conventional natural language processing (NLP) tasks. Many LLMs are trained or otherwise fine-tuned to perform zero-shot or few-shot inference using instruction-based prompts. Crafting prompts for these LLMs typically involves a user providing a detailed task description, examples of context and completion (demonstrations), and a single example of context for inference. This regular prompt baseline is referred to herein a prompt input or a single prompt. For natural language processing (NLP) tasks where each data point for inference is not necessarily lengthy, the token count for instructions and few-shot examples in the prompt may be considerably larger than that of the data point, resulting in lower token-resource utilization compared with encoder-based models (e.g., like finetuned BERT). This cost-efficiency issue, affecting inference speed and compute budget, counteracts many benefits LLMs have to offer. As discussed above, and as will be discussed in further detail below, features and functionality of the batch prompt generation system described herein aims to alleviate efficiency and scaling problems by batching multiple data points into a single prompt (a batch prompt). This strategy increases the “density” of data points, which in turn leads to improved token utilization.

As will be discussed in further detail, applying a batch prompt naively can be challenging due to performance degradation. In addition, due to performance changing as a result of data points appearing in different positions within a prompt, batching without considering the order of the data points can result in inaccuracies. To address the quality issue while maintaining high token resource utilization, implementations of the batch prompt generation system described herein introduce batch permutation and ensembling as well as filtering or removing certain datapoints between subsequent permutations of a batch input. As discussed herein, the batch prompt generation system can provide increased performance of batch-prompting techniques for a wide range of popular NLP tasks, including question answering (Boolq), textual entailment (RTE), and duplicate questions identification (QQP). These performance improvements are even competitive with, and in some cases provide even better performance than, single-data prompting (SinglePrompt), based on metrics of utilizing fewer LLM calls, input tokens, and/or API calls when performing batch-prompting.

As illustrated in the foregoing discussion, the present disclosure utilizes a variety of terms to described features and advantages of one or more embodiments of the batch prompt generation system. Additional detail will now be provided regarding the meaning of some of these terms. Further terms will also be discussed in detail in connection with one or more embodiments and specific examples below.

As used herein, a “large language model” or simply “LLM” refers to an AI or ML model that is trained to generate an output in response to an input based on a large dataset. In one or more embodiments described herein, an LLM may refer more generally to a foundation model. An LLM may include a neural network having a significant number of parameters (e.g., billions of parameters) that the LLM can consider in performing a task or otherwise generating an output based on an input. In one or more embodiments, an LLM is trained to generate a response to a query or prompt. The LLM may be trained in pattern recognition and text prediction. For example, an LLM may be trained to predict the next word of a particular sentence or phrase. As another example, an LLM may be trained to predict whether a particular sentence includes any errors. As another example, an LLM may be trained to select an output from a predetermined number of outputs. Indeed, an LLM may be trained to generate any of a variety of outputs based on any of a variety of input prompts. In one or more embodiments, an LLM is a version or generation of GPT (e.g., GPT 3.5, GPT 4.0) or other brand or variation of an LLM that accepts and processes natural language queries (or other types of input queries). Indeed, while one or more embodiments described herein refer to features associated with determining context for an LLM, similar features may apply to generating context and determining outputs using other types of foundation models.

As used herein, an input prompt refers to a statement including data and a task to perform with respect to the data. In one or more embodiments, the input prompt is generated based on a query that is provided as input to the LLM. Nevertheless, in one or more embodiments described herein, an input prompt refers to a task (e.g., a task specification) and an associated data input (e.g., a data specification) including data to be processed or labeled by the LLM in accordance with a context that takes into account a knowledge base, the task, and any other data provided to the LLM in connection with the input query.

In one or more embodiments, multiple input prompts are included or otherwise combined within a batch prompt. In one or more embodiments described herein, the batch prompt is a combination of a task (or multiple similar tasks) with multiple data inputs. For example, in response to a plurality of input prompts, a batch prompt generation system can generate a batch prompt including a combined task based on the task(s) of the multiple data inputs and data inputs from the plurality of input prompts. The resulting batch prompt may include a single task and any number of data inputs on which to perform the single task. Examples will be discussed below in connection with the figures.

In one or more embodiments, the batch prompt generation system generates one or more permutations of the batch prompt. As used herein, a permutation of a batch prompt or batch permutation refers to a batch prompt in which instances of the input data have been reordered in a unique sequence. For example, a batch permutation may include a similar task as a corresponding batch prompt and a similar set of data inputs; however, the permutation may include the data inputs reordered within the batch permutation. In one or more implementations, the permutation is a random permutation in which an order of the input data has been randomized.

As used herein, an output of the LLM may include any of a variety of outputs in accordance with a training of the LLM. For example, an output may include an answer or performance of the task of the batch prompt with respect to any number of the input data. In addition to the answer or performance of the task, the output may include a confidence value determined by the LLM indicating a metric of confidence or likelihood that the answer or performance of the task was done correctly and represents an accurate output responsive to the task and data input. The output may include any answer, result, response, performance of a task, or any other output.

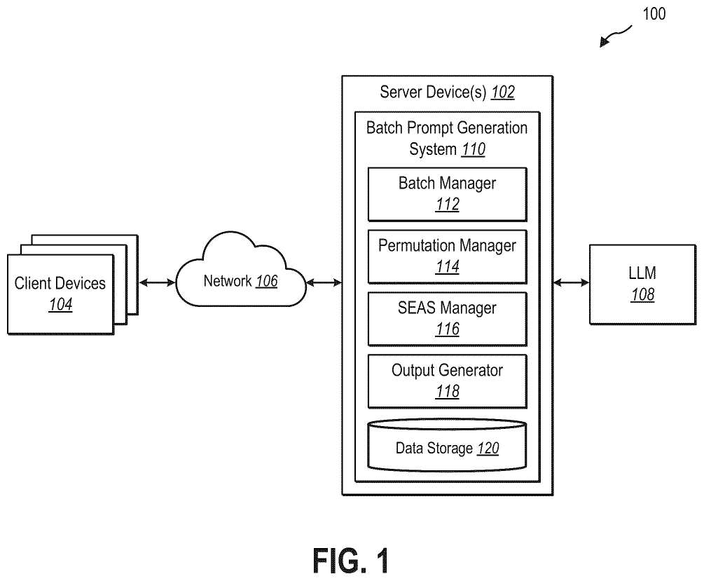

Additional detail will now be provided regarding a batch prompt generation system in accordance with one or more example implementations. For example, FIG. 1 illustrates a block diagram showing an environment 100 having one or more server devices 102 (or other computing devices) on which a batch prompt generation system 110 is implemented. The environment 100 additionally includes one or more client devices 104 in communication with the server device(s) 102 via a network 106. As further shown, the server device(s) 102 include or otherwise have access to an LLM 108 for performing one or more tasks in connection with data inputs. As shown in FIG. 1, the batch prompt generation system 110 includes a number of components, which will be discussed in further detail below.

As shown in FIG. 1, the client devices 104 and server device(s) 102 (and the device(s) on which the LLM 108 are implemented) can communicate with each other directly or indirectly through a network 106. The network 106 may include one or multiple networks and may use one or more communication platforms or technologies suitable for transmitting data. The network 106 may refer to any data link that enables the transport of electronic data between devices and/or modules of the environment 100. The network 106 may refer to a hardwired network, a wireless network, or a combination of hardwired and wireless networks. In one or more embodiments, the network 106 includes the Internet.

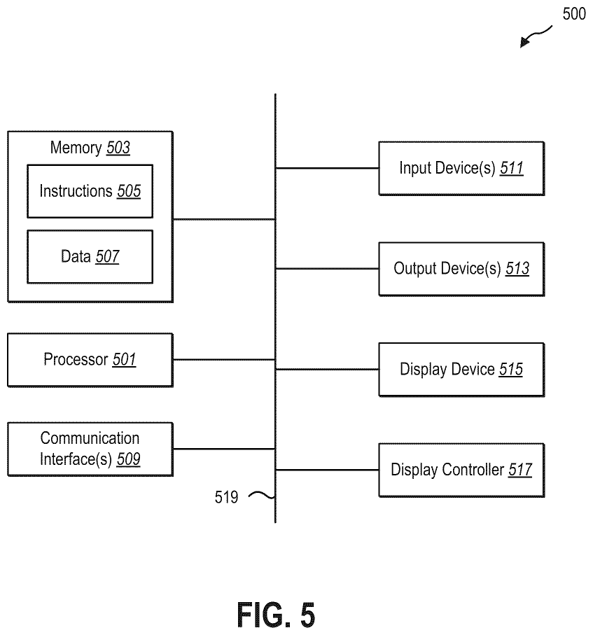

The client devices 104 and server device(s) 102 may refer to various types of computing devices. For example, in one or more embodiments, the client devices 104 may include a mobile device, such as a mobile telephone, a smartphone, a PDA, a tablet, or a desktop. In one or more embodiments, the client devices 104 may include a non-mobile device such as a desktop computer, server device, or other non-portable device. In one or more embodiments, the client devices 104 refer to clients (e.g., internal clients or external clients) of a cloud computing system. In one or more embodiments described herein, the server device(s) 102 refer to one or more server devices of a cloud computing system accessible to a client device (e.g., a consumer device operated by a user). In one or more implementations, the server device(s) 102 refer to one or more third-party server device(s) independent from the client devices 104. Each of the client device 104s and server device(s) 102 may include features and functionality described below in connection with FIG. 5.

As mentioned above, and as shown in FIG. 1, the batch prompt generation system 110 includes a number of components for performing acts and providing functionalities described herein. By way of example, the batch prompt generation system 110 may include a batch manager 112, a permutation manager 114, a self-reflection-guided early stopping (SEAS) manager 116 (or simply an “early stopping manager”), an output generator 118, and a data storage 120 which provides access to data stored or accessible to the data storage 120 to any of the components of the batch prompt generation system 110 in performing features and functionalities described herein.

As further shown, the batch prompt generation system 110 may communicate with an LLM 108 (e.g., one or more devices on which the LLM 108 is implemented). In one or more embodiments, the LLM 108 is stored or contained within the computing environment of the server device(s) 102. In some implementations, the LLM 108 is external to the batch prompt generation system 110 (such as a 3^{rd} party LLM). In one or more embodiments, the LLM 108 is a combination of multiple models that collectively perform one or more tasks with respect to data inputs.

It will be understood that while FIG. 1 illustrates an example in which each of the components of the batch prompt generation system 110 are implemented in whole on the server device(s) 102, other implementations may include one or more components (or sub-components) implemented across different devices of the environment 100. As a non-limiting example, one or more of the batch manager 112, permutation manager 114, SEAS manager 116, and/or output generator 118 may be implemented on different computing devices (e.g., on different server nodes of a cloud computing system or across different cloud computing platforms altogether). One or more of the components may be implemented in whole or in part on a client device 104, such as batching prompts on a client device 104 and other steps being performed on the server device(s) 102. In addition, while the LLM 108 is shown as external to the server device(s) 102, in one or more embodiments, the LLM 108 is included as a component of the batch prompt generation system 110 and may be implemented on the server device(s) 102 in combination with the other components shown in FIG. 1.

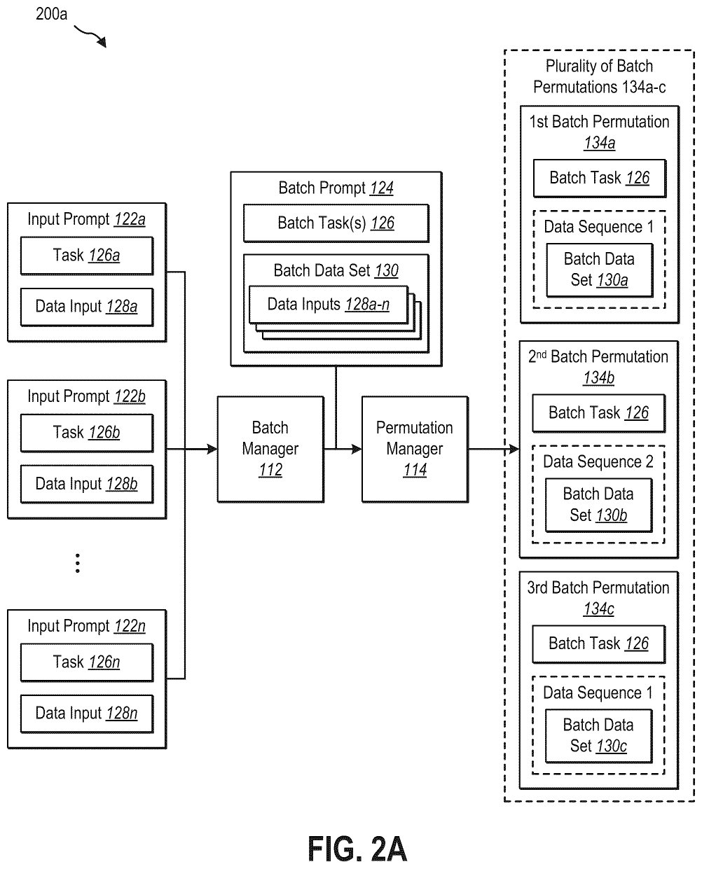

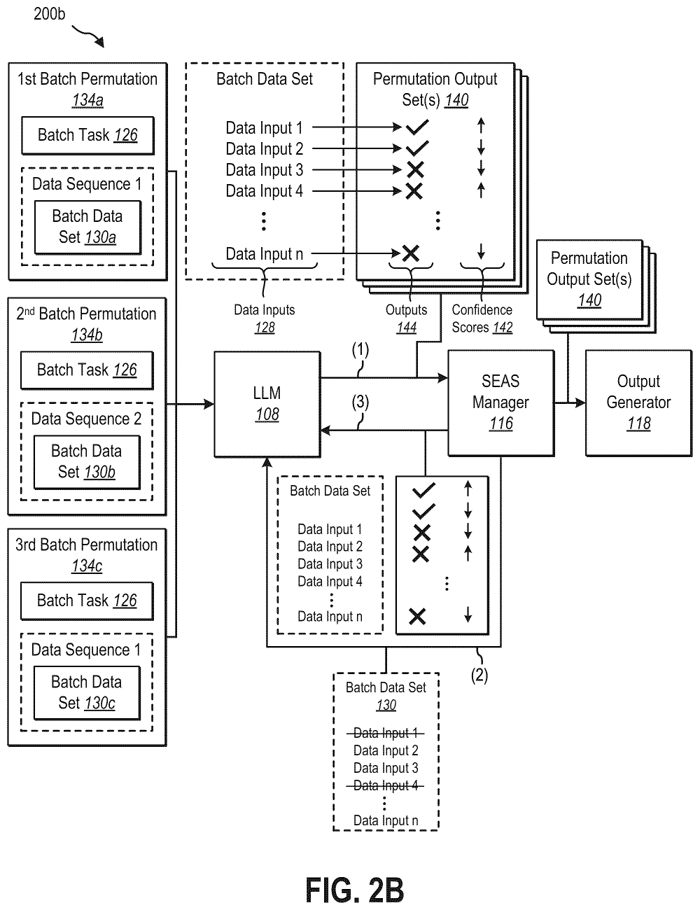

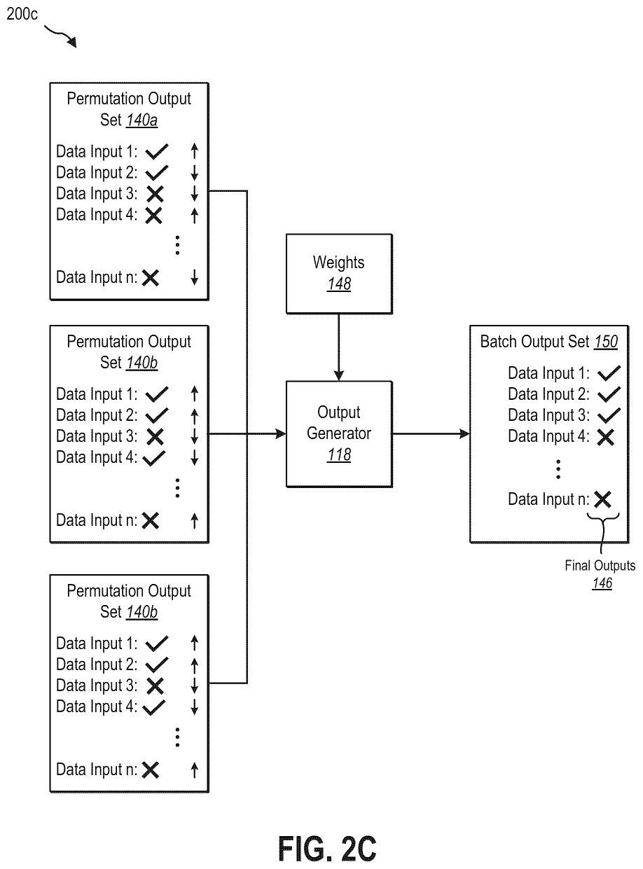

Additional detail with respect to the components of the batch prompt generation system 110 will be discussed in connection with additional figures. For example, FIG. 2A illustrates an example workflow 200 (e.g., a portion of a workflow) in which a batch manager 112 receives a plurality of input prompts 122a-n. As noted above, the input prompts 122a-n may include a task 126 and associated data input(s) 128. In one or more implementations, each of the input prompts 122a-n includes a task and an associated data input. In one or more implementations, the input prompts 122a-n are related to performing the same or similar type of task. For example, each of the tasks 126a-n may refer to the same (e.g., identical) or similar type of task in connection with unique or different data inputs 128a-n.

In one or more implementations, the batch prompt generation system 110 receives a plurality of input prompts 122a-n. The batch prompt generation system 110 may group the input prompts 122a-n within respective groupings. For example, the batch manager 112 may receive a plurality of input prompts 122a-n and categorize them based on the tasks 126a-n that are included. For instance, the batch manager 112 may categorize the input prompts 122a-n within a first grouping according to a (e.g., same or similar) first task and a second grouping according to a (e.g., identical or similar) second task. The batch manager 112 may group the input prompts 122a-n in accordance with any of a variety of criteria or characteristics of the input prompts 122a-n. In one or more implementations, the batch manager 112 groups the input prompts 122a-n based on a programming of an LLM 108 to process the respective input prompts 122a-n within a single batch.

As shown in FIG. 2A, the batch manager 112 generates a batch prompt 124 based on content included within the received input prompts 122a-n. In one or more embodiments, the batch manager 112 generates a batch prompt 124 based on a set of input prompts 122a-n determined to be related (e.g., based on having a similar or identical tasks 126a-n associated with corresponding data inputs 128a-n). As shown in FIG. 2A, the task of the batch prompt 124 is referred to generally as batch task(s) 126. As shown in FIG. 2A, the batch manager 112 generates a batch prompt 124 including the batch task 126 (or set of similar tasks) and an associated batch data set 130 including the data inputs 128a-n from each of the (e.g., related) input prompts 122a-n. The batch manager 112 may provide the batch prompt 124 including the batch task 126 and batch data set 130 to the permutation manager 114.

The permutation manager 114 may generate any number of batch permutations 134a-c of the batch prompt 124. As noted above, a batch permutation may include variations of the batch prompt 124 in which the data inputs 128a-n for a given task are reordered into a specific and unique sequence or ordering. In the example shown in FIG. 2A, a plurality of batch permutations 134a-c includes a first batch permutation 134a including the batch task(s) 126 (e.g., of the batch prompt 124) and a first batch data set 130a ordered into a data sequence 1. The plurality of batch permutations 134 further includes a second batch permutation 134b including the task(s) 126 and a second batch data set 130b ordered into a data sequence 2. The plurality of batch permutations 134 further includes a third batch permutation 134c including the task(s) 126 and a third batch data set 130c ordered into a data sequence 3. Each of the batch data sets 130a-c may include a similar combination of data inputs 128a-n reordered (e.g., randomly) in accordance with the respective data sequence. In this way, each of the plurality of batch permutations 134 may include the tasks(s) 126 and all of the data inputs 128a-n of the batch prompt 124 (and of the input prompts 122a-n) but ordered in a unique data sequence.

While FIG. 2A illustrates an example in which the plurality of batch permutations 134a-c includes three permutations, additional or fewer permutations may be used. For example, in one or more implementations, the permutation manager 114 generates a single batch permutation to provide to the LLM 108 in addition to the original batch prompt 124. In one or more implementations, the permutation manager 114 generates two or more batch permutations. In one or more embodiments, the permutation manager 114 generates batch permutation(s) and determines if one or more additional batch permutations should be generated. For example, the permutation manager 114 may provide the batch permutations 134a-c to the LLM 108, and may determine a confidence score based on the corresponding outputs from the LLM 108. The permutation manager 114 may generate one or more additional batch permutations based on the confidence scores (e.g., if the confidence scores are not sufficiently high).

It will be understood that while the data sequences for the batch data sets 130a-c in the batch permutations 134a-c are randomized (or simply reordered) versions of the original batch prompt 124, in one or more embodiments described herein, the LLM 108 may be applied to any of the batch permutations in a similar manner as when applying the LLM 108 to the original batch prompt 124. Thus, in an example below where the LLM 108 is applied to a first batch permutation 134a and a second batch permutation 134b, this may refer to the LLM 108 being applied to the original batch prompt 124 and any of the batch permutations 134a-c. Alternatively, this may refer to the LLM 108 being applied to any of the batch permutations 134a-c and then the original batch prompt 124. Alternatively, this may refer to the LLM being applied to two of the batch permutations 134a-c (with or without first applying the LLM to the original batch prompt 124).

While FIG. 2A illustrates an example in which a batch manager 112 generates a batch prompt 124 and a permutation manager 114 generates a set batch of permutations 134, it will be appreciated that this is an example implementation provided as an explanation of one possible workflow. In one or more embodiments, the batch manager 112 and permutation manager 114 are implemented as a single component that generates a plurality of batch prompts including any number of batch permutations having different data sequences of the batch data set. Thus, while one or more examples described herein involve generating an original batch prompt 124 and then creating permutations 134a-c based on the original batch prompt 124, the batch prompt generation system 110 may generate one or more batch prompts 124 including batch prompts having different ordered sets of the data inputs 128 (e.g., different data sequences of the batch data set 130). As an example, the batch prompt generation system 110 may generate a first batch prompt having a first ordered set of the data inputs 128 and a second batch prompt having a second ordered set of the data inputs 128. The batch prompt generation system 110 may generate any number of batch prompts 124 including different ordered sets of the data inputs 128.

Moving on, FIG. 2B illustrates a next portion of the workflow 200 described in FIG. 2A. As shown in FIG. 2B, a plurality of batch permutations 134a-c (e.g., including the batch permutations 134a-c and/or the original batch prompt 124 as shown in FIG. 2A) may be provided as inputs to the LLM 108. The LLM 108 may analyze the batch data set 130a-c of each of the batch permutations 134 with respect to the task 126. As noted above, the LLM 108 may evaluate the batch data sets 130a-c in the specific order or data sequence in which the data inputs are ordered within the respective batch data sets 130a-c within each respective batch permutation.

For example, where a first batch permutation 134a includes the batch data set 130a ordered in a first data sequence (e.g., data sequence 1), the LLM 108 may evaluate the data inputs 128 in that specific order and update context used by the LLM 108 as the data inputs 128 are iteratively evaluated (e.g., as the task 126 is performed or evaluated with respect to each data input 128). In one or more embodiments, the LLM 108 updates the context (e.g., the prompt or query context used by the LLM 108 to generate outputs based on corresponding inputs) with the evaluation of each data input 128. In one or more embodiments, the LLM 108 updates the context with the evaluation of every two or three data inputs 128 (or other predetermined number of data inputs 128).

After evaluating a first batch permutation 134a of the plurality of batch permutations 134a-c, the LLM 108 may be used to again evaluate a second batch permutation 134b in a similar fashion. In this example, the LLM 108 may start with an initial context and apply the LLM 108 to each data input 128 of the batch data set 130 in the second ordered sequence (e.g., data sequence 2) of the second batch permutation 134b. Similar to evaluating the first batch permutation 134a, the LLM 108 can evaluate the second batch data set 130b in the specific order of the second data sequence and update the context used by the LLM 108 as the data inputs 128 are processed and as the task(s) 126 are performed with respect to the data inputs 128. The LLM 108 may update the context iteratively in a similar fashion as discussed above.

In some embodiments, the LLM 108 evaluates the data inputs 128 of the batch data sets in the associated data sequence orders for each batch permutation 134 as described above, and generates an output 144 for each data input 128 of the respective batch data sets. For example, the LLM 108 may evaluate each of the data inputs 128 with respect to the task 126 and may determine a corresponding answer, result, response, or other output as the output 144 for that data input 128. For instance, as shown in FIG. 2B, the LLM 108 may evaluate each of the data inputs 128 and determine an output 144 of correct or incorrect for each data input 128. The LLM 108 may generate a permutation output set 140 in this manner for each of the batch permutations 134a-c. Based on the plurality of permutation output sets 140, the batch prompt generation system 110 may determine a batch output set 150 (e.g., a final result, or batch prompt output) for the task 126 applied to the batch data set 130. The batch prompt generation system 110 may determine the batch output set 150 in accordance with various techniques described below, such as that described in connection with FIG. 2C.

In some embodiments, the LLM 108 may determine confidence scores 142 for each of the outputs 144. For example, the LLM 108 may determine, upon evaluating each of the data inputs 128 with respect to the task 126, a confidence of the accuracy of the associated output 144. For instance, the LLM 108 may assess whether it determined each output 144 with a high confidence (e.g., at or above a threshold confidence value) or a low confidence (e.g., under the threshold confidence value or other threshold). As shown in FIG. 2B, the LLM 108 may indicate the associated confidence score 142 in association with the outputs 144 of the permutation output set 140.

As shown in FIG. 2B, the LLM 108 may optionally provide one or more of the permutation output sets 140 to the SEAS manager 116. In this example, the permutation output sets 140 are provided to the SEAS manager 116 as the permutation output sets 140 are generated and as each batch permutation 134 is iteratively analyzed. For example, the LLM 108 may generate and provide a first permutation output set 140a for a first batch permutation 134a and may then generate and provide a second permutation output set 140b for a second batch permutation 134b. The SEAS manager 116 may then perform a narrowing or filtering process on the data inputs 128 of the batch data set 130 in a way that enables the batch manager 112, LLM 108, or other component of the batch prompt generation system 110, to generate and/or evaluate new and/or subsequent batch permutations 134 having a fewer number of data inputs 128 to be processed by the LLM 108.

In one or more embodiments, the SEAS manager 116 narrows down the batch data set 130 between iterations of evaluating batch permutations 134 by considering the confidence scores 142 that are determined or otherwise generated by the LLM 108 with respect to the permutation output sets 140 (e.g., output sets 140a-b). For example, in one or more embodiments, the SEAS manager 116 removes a specific data input 128 for a subsequent batch permutation 134 based on one or more outputs 144 corresponding to the data input 128 having a high confidence score 142 that the output 144 is accurate. For example, as shown in FIG. 2B, the outputs 144 show a high confidence score for data input 1 and data input 4, and the SEAS manager 116 accordingly may remove data input 1 and data input 4 such that the LLM 108 may not evaluate those data inputs in connection with future batch permutations. In one or more embodiments, the SEAS manager 116 removes a data input 128 for future batch permutations based on multiple iterations of an output 144 for a corresponding data input 128 having a high confidence score 142. For example, the SEAS manager 116 may remove a data input 128 from the third batch data set 130c based on a corresponding output 144 being the same or similar for multiple iterations and/or based on the output 144 having a high confidence score for multiple iterations. The multiple iterations of a high confidence score for an output 144 may be in connection with evaluations of multiple batch permutations that are consecutive, or simple any two or more non-consecutive batch permutations. In this manner, a resulting third output set 140c may include fewer data inputs than previous iterations of the first and second output sets 140a-b.

In this way the SEAS manager 116 may maintain a record of the resulting outputs 144 and associated confidence scores 142 for each data input 128 of the batch data set 130, and may iteratively narrow the batch data set 130 by eliminating data inputs 128 determined multiple times with a high confidence. The SEAS manager 116 may narrow the batch data set 130 in this way to include a fewer number of data inputs 128 that are associated with a high confidence score for the evaluations of future batch permutations 134. Accordingly, the batch data set 130 may be continually and selectively narrowed for future batch permutations 134 to promote efficiency of the LLM 108 in evaluating the (e.g., remaining data inputs 128 of the) batch data set 130, as well as facilitating devoting computing resources to processing those data inputs 128 which have not yet been evaluated with high confidence.

This iterative narrowing by the SEAS manager 116 is illustrated in FIG. 2B by a data flow (1) showing the LLM determining and providing one or more permutation output sets 140 to the SEAS manager 116, a data flow (2) showing the SEAS manager 116 accordingly narrowing the batch data set 130 by eliminating data inputs 128 associated with a high confidence, and a data flow (3) showing the LLM 108 determining and providing one or more additional permutations output sets 140 based on the reduced version of the batch data set 130. The batch prompt generation system 110 may run any number of iterations while further reducing the data inputs 128 any number of times to include only those data inputs for which the LLM 108 is less than a threshold metric of confidence in the corresponding outputs 144.

The SEAS manager 116 may stop iteratively narrowing the batch data set 130, and/or may stop iteratively causing batch permutations to be generated and/or evaluated based on a variety of factors. In one or more embodiments, the SEAS manager 116 causes a predetermined number of batch permutations to be generated and analyzed (e.g., three to ten batch permutations). In one or more embodiments, the SEAS manager 116 causes any number of batch permutations to be generated and analyzed based on how many data inputs have been removed due to a sufficient threshold of confidence being satisfied with respect to the specific data inputs. For example, the SEAS manager 116 may cause up to a threshold number of batch permutations 134 to be generated until a threshold percentage or number of data inputs 128 have been removed or until a token budget or computational budget has been expended.

FIG. 2C illustrates a continuation of the workflow 200 shown in FIGS. 2A and 2B. In this example, the SEAS manager 116 provides a plurality of the permutations output sets 140a-c to the output generator 118. The output generator 118 may consider the outputs for each of the data inputs from across the plurality permutation output sets 140a-c to determine a batched output set 150 (or batch prompt output) including a set of final outputs 146. As mentioned above, the batch output set 150 may be a set of outputs determined to be responsive to the batch prompt 124 and/or responsive to the plurality of input prompts 122a-c used in generating the batch prompt 124. In one or more embodiments, the output generator 118 generates the batch output set 150 based on the outputs 144 of the permutation output sets 140a-c received from the SEAS manager 116 (or as received from the LLM 108, such as in the case that the SEAS manager 116 is not used, and the batch data set(s) is not narrowed).

The output generator 118 may consider the combination of outputs 144 of the plurality of permutation output sets 140a-c in a variety of ways to determine the final outputs 146 for the batch output set 150. For example, the output generator 118 may determine the final output 146 for a given data input based on a majority vote (e.g., simple majority or large majority) of the outputs 144 of the permutations output sets 140a-c associated with the data input 128. In this way, the permutation output sets 140a-c may “vote” on the final output 146 for each data input of the batch data set 130 based on associated outputs 144 of the respective output sets 140a-c, and the final output 146 may be determined by a majority vote.

In some embodiments, the output generator 118 applies weights 148 to the outputs 144 (e.g., weights the votes of the permutation output sets 140a-c) based on different criteria. In some embodiments, the weights 148 may be determined by and/or may be associated with the confidence scores 142 for each data input of the permutation output sets 140a-c. For example, based on the level of confidence assigned by the LLM 108 during evaluation of a given data input of a given batch permutation, a weight 148 may be accordingly assigned. For instance, a determination of a high confidence score 142 may be assigned a weight 148 of 1.0. A determination of a low confidence score 142 may be assigned a weight of 0.2. Any other weights 148 may be determined and assigned for any associated level of confidence. The output generator 118 may accordingly apply the weights 148 to the respective outputs 144 (or votes) and may accordingly determine the final outputs 146 based on the weighted values. For example, the final outputs 146 may be determined as a self-weighted majority vote, or as a majority based on the weighted votes. In this way, the output generator 118 may generate the batch output set 150 corresponding with the answers, results, responses, or other outputs for the task 126 as applied to each of the input data instances represented within the batch prompt 124, which, as discussed above, may include a final output 146 for each of the input prompts 122a-c that are used in generating the batch prompt 124.

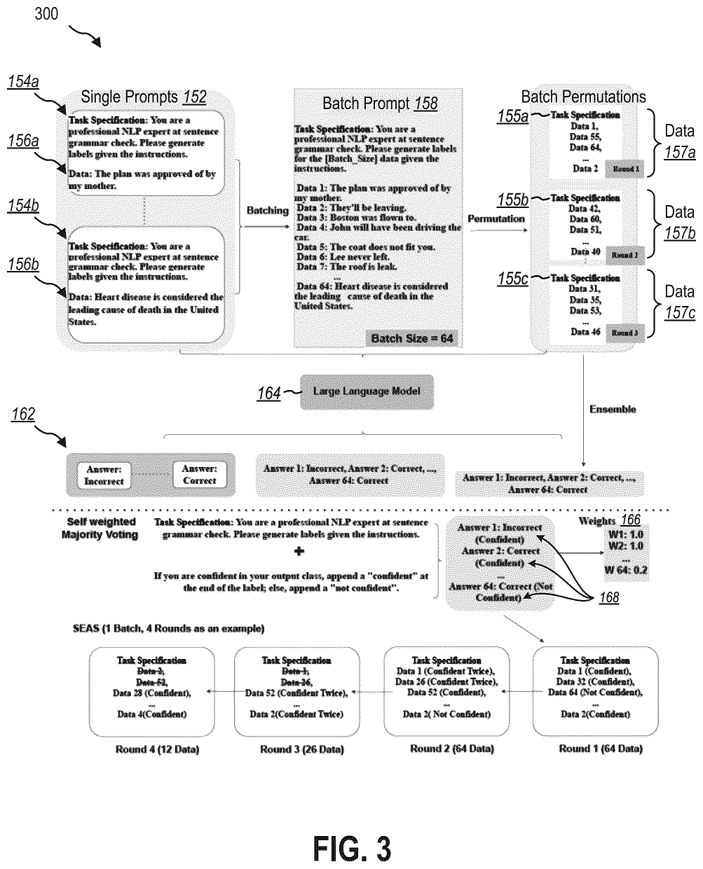

FIG. 3 illustrates another example workflow 300 showing an example implementation of the batch prompt generation system 110 in accordance with one or more embodiments described herein. As shown in FIG. 3, the batch prompt generation system 110 may receive a plurality of single prompts 152. In this example, each single prompt(s) 152 may include a task specification 154 indicating a task of generating labels for a grammar check of a corresponding statement. In this example, the statement refers to a data instance (e.g., data 156a). The batch prompt generation system 110 may receive any number of single prompts 152. In this example, the batch prompt generation system 110 receives sixty-four single prompts 152 having similar task specifications 154 and different data 156.

The batch prompt generation system 110 may generate a batch prompt 158. As shown in FIG. 3, the batch prompt 158 includes a single task statement or the task specification(s) and a listing of sixty-four data instances on which a task (corresponding to the tasks 154) is to be performed. As further shown, the batch prompt generation system 110 may perform a batch permutation and ensembling process to generate a number of batch permutations 155a-c. In this example, the batch prompt generation system 110 generates three batch permutations 155a-c, or three rounds of batches including reordered data instances 157a-c. In this example, the data instances 157a-c are reordered randomly. Other reordering mechanisms may be used.

As shown in this example, the batch prompt generation system 110 may determine answers 162 for each of the data instances 157a-c in each of the batch permutations 155a-c. For example, the batch prompt generation system 110 may determine an answer of “correct” or “incorrect” for each data instance. The batch prompt generation system 110 may apply an LLM 164 to a first batch permutation to determine a first set of “correct” and “incorrect” answers for a first batch permutation 155a. The batch prompt generation system 110 may then apply the LLM 164 to a second batch permutation 155b to determine a second set of “correct” and “incorrect” answers for an ordering of the data instances associated with the second batch permutation 155b.

Consistent with one or more embodiments described herein, the batch prompt generation system 110 may apply the LLM 164 to each of the batch permutations 155a-c. Alternatively, in one or more embodiments, the batch prompt generation system 110 may iteratively apply the LLM 164 to each of the batch permutations 160 and apply the SEAS process to narrow down the data instances 156 for subsequent batch permutations 160 with each iteration (or after a first predetermined number of iterations) of applying the LLM 164 to the batch permutations, as described herein.

In one or more embodiments, the batch prompt generation system 110 applies weights 166 to the answers 162 based on confidence scores 168. As an example, the batch prompt generation system 110 may consider three sets of answers 162 associated with three batch permutations 155a-c to determine a batch output set based on the combination of the respective sets of answers 162. In this example, the batch prompt generation system 110 may apply a first weight (e.g., 0.2) to each answer that has a confidence score 168 less than a threshold. The batch prompt generation system 110 may alternatively apply a second higher weight (e.g., 1.0) to each answer 162 that has a confidence score 168 at or above the threshold (or other threshold). Other examples may include different ranges of confidence scores 168 that are associated with different weights 166. The batch output set based on the combination of individual answers 162 may be based on a combination (e.g., a majority) of the answers 162 as weighted by corresponding weights 166.

In addition to the weights 166, the batch prompt generation system 110 may consider additional or fewer rounds of the batch permutations 160 based on certain eliminations or filtering of data instances between the evaluations of batch permutations 155a-c. For example, as shown in FIG. 3, a first evaluation of a first batch permutation 155a may include sixty-four data instances 157a that are processed and considered using the LLM 164. Similarly, a second evaluation of a second batch permutation 155b may include sixty-four data instances 157b. In this example, where two data instances are each associated with two high confidence scores 168, the batch prompt generation system 110 may perform a third evaluation of a reduced version of the third batch permutation 155c in which only twenty-six data instances are considered in associated with the third batch permutation 155c. The batch prompt generation system 110 may remove one or more additional data instances in a fourth evaluation of a fourth batch permutation in which only twelve data instances are considered. The batch prompt generation system 110 may stop after some threshold number of rounds (e.g., after a threshold number of batch permutations have been evaluated) or after a certain number or percentage of data instances have been removed. In the event that the LLM 164 does not become confident with an associated answer 162 of one or more of the data instances 156, the batch prompt generation system 110 may simply implement the voting or weighted method discussed above in generating an answer based on a combination of the associated answers 162 for the data instance of each of the batch permutations.

The above-examples are intended to illustrate example features and functionality of the batch prompt generation system 110 in generating a set of outputs responsive to a plurality of input prompts (or a batch of input prompts) that are provided as inputs to an LLM.

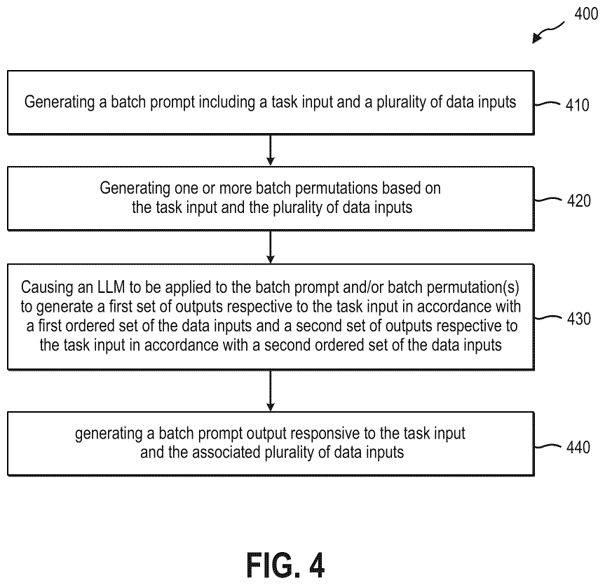

Turning now to FIG. 4, this figure illustrates example flowcharts including series of acts for efficiently processing a plurality of input prompts in accordance with one or more embodiments described herein. While FIG. 4 illustrates acts according to one or more embodiments, alternative embodiment may omit, add to, reorder, and/or modify any of the acts shown in FIG. 4. The acts of FIG. 4 can be performed as part of a method. Alternatively, a non-transitory computer-readable medium can include instructions that, when executed by one or more processors, cause a computing device to perform the acts of FIG. 4. In still further embodiments, a system can perform the acts of FIG. 4.

For example, FIG. 4 illustrates a series of acts 400 for efficiently processing a plurality of input prompts. As shown in FIG. 4, the series of acts 400 includes an act 410 of generating a batch prompt including a task input and a plurality of data inputs. In one or more implementations, the act 410 includes generating a batch prompt including a task input and a plurality of data inputs associated with the task input, the plurality of data inputs having a first order. In one or more embodiments, the plurality of data inputs could refer to a subset of data inputs from a collection of data inputs associated with the task input. In this instance, subset could refer to a proper subset (e.g., some, but not all of a collection of received data inputs) or could refer to all of a set of data inputs.

The series of acts 400 additionally includes an act 420 of generating one or more batch permutations based on the task input and the plurality of data inputs. In one or more embodiments, the act 420 includes generating one or more batch permutations based on the batch prompt, each batch permutation of the one or more batch permutations including data inputs from the plurality of data inputs in a different order from the first order. The batch permutations may include data inputs from the plurality of data inputs in differing orders. The batch permutations may include a first batch permutation in which the plurality of data inputs are reordered relative to the first order. The batch permutations may include a second batch permutation in which the plurality of data inputs are reordered relative to the first order.

The series of acts 400 includes an act 430 of causing an LLM to be applied to the batch prompt and/or batch permutation(s) to generate a first set of outputs respective to the task input in accordance with a first ordered set of the data inputs and a second set of outputs respective to the task input in accordance with a second ordered set of the data inputs. In one or more embodiments, the act 430 includes applying a large language model to the batch prompt and the one or more batch permutations to generate (1) a first set of outputs responsive to the task input based on the plurality of data inputs and (2) a second set of outputs responsive to the task input based on the data inputs from the plurality of data inputs of the one or more batch permutations. In some embodiments, the method includes determining a confidence value for each output from the first set of outputs and the second set of outputs. In some embodiments, one or more weights may be determined for each output from the first set of outputs and the second set of outputs based on the confidence score. For example, the one or more weights may include one or more high weight values based on the large language model determining that corresponding outputs are likely accurate. The one or more weights may include one or more low weight values based on the large language model determining that the corresponding outputs are likely inaccurate.

The one or more batch permutations may include a plurality of additional permutations, wherein the second set of outputs includes a set of outputs for each permutation. The one or more batch permutations may include reduced sets of data inputs. For example, the reduces sets of data inputs may have had one or more data inputs removed based on the one or more data inputs having associated outputs with high associated confidence values.

The series of acts 400 additionally includes an act 440 of generating a batch prompt output responsive to the task input and the associated plurality of data inputs. In one or more embodiments, the act 440 involves generating a batch prompt output responsive to the batch prompt, the batch prompt output including a plurality of outputs based on the first set of outputs and the second set of outputs. In one or more implementations, the batch of outputs is a collected set of outputs that are included within a single final output in which each of the outputs are determined by a majority or weighted vote between the respective outputs of the individual batch permutations.

In one or more embodiments, the one or more batch permutations include a first permutation of the plurality of data inputs, the first permutation including a first reordered set data inputs in which the plurality of data inputs are reordered relative to the first order. In one or more embodiments, the one or more batch permutations include a second permutation of the plurality of data inputs, the second permutation including a second reordered set of data inputs in which the plurality of data inputs are reordered relative to the first order. In one or more embodiments, the one or more batch permutations includes a plurality of additional permutations of the plurality of data inputs where the second set of outputs includes a set of outputs for each permutation from the first permutation, second permutation, and the plurality of additional permutations. In one or more embodiments, the series of acts 400 includes determining a confidence value for each output from the first set of outputs and the second set of outputs.

In one or more embodiments, the one or more of the batch permutations includes a reduced sets of data inputs. In one or more embodiments, the reduced sets of data inputs exclude one or more data inputs based on the one or more data inputs having associated outputs from the first set of inputs or the second set of inputs with high associated confidence values.

In one or more embodiments, generating the batch prompt output includes determining one or more weights for each output from the first set of outputs and the second set of outputs based on a confidence score determined by the large language model with respect to each output from the first set of outputs and the second set of outputs. In one or more embodiments, the one or more weights include one or more high weight values based on the large language model determining that corresponding outputs are likely accurate, and the one or more weights include one or more low weight values based on the large language model determining that the that corresponding outputs are likely inaccurate.

FIG. 5 illustrates certain components that may be included within a computer system 500. One or more computer systems 500 may be used to implement the various devices, components, and systems described herein.

The computer system 500 includes a processor 501. The processor 501 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) could be used. In one or more embodiments, the computer system 500 further includes one or more graphics processing units (GPUs), which can provide processing services related to both entity classification and graph generation.

The computer system 500 also includes memory 503 in electronic communication with the processor 501. The memory 503 may be any electronic component capable of storing electronic information. For example, the memory 503 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

A computer system 500 may also include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 500 may also include one or more input devices 511 and one or more output devices 513. Some examples of input devices 511 include a keyboard, mouse, microphone, remote control device, button, joystick, trackball, touchpad, and lightpen. Some examples of output devices 513 include a speaker and a printer. One specific type of output device that is typically included in a computer system 500 is a display device 515. Display devices 515 used with embodiments disclosed herein may utilize any suitable image projection technology, such as liquid crystal display (LCD), light-emitting diode (LED), gas plasma, electroluminescence, or the like. A display controller 517 may also be provided, for converting data 507 stored in the memory 503 into text, graphics, and/or moving images (as appropriate) shown on the display device 515.

The various components of the computer system 500 may be coupled together by one or more buses, which may include a power bus, a control signal bus, a status signal bus, a data bus, etc. For the sake of clarity, the various buses are illustrated in FIG. 5 as a bus system 519.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular datatypes, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for processing batches of inputs using one or more large language models, the method comprising:
generating a batch prompt including a task input and a plurality of data inputs associated with the task input, the plurality of data inputs having a first order;
generating one or more batch permutations based on the batch prompt, each batch permutation of the one or more batch permutations including data inputs from the plurality of data inputs in a different order from the first order;
applying a large language model to the batch prompt and the one or more batch permutations to generate:
a first set of outputs responsive to the task input based on the plurality of data inputs; and
a second set of outputs responsive to the task input based on the data inputs from the plurality of data inputs of the one or more batch permutations; and
generating a batch prompt output responsive to the batch prompt, the batch prompt output including a plurality of outputs based on the first set of outputs and the second set of outputs.

2. The method of claim 1, wherein the one or more batch permutations include a first permutation of the plurality of data inputs, the first permutation including a first reordered set data inputs in which the plurality of data inputs are reordered relative to the first order.

3. The method of claim 2, wherein the one or more batch permutations include a second permutation of the plurality of data inputs, the second permutation including a second reordered set of data inputs in which the plurality of data inputs are reordered relative to the first order.

4. The method of claim 3, wherein the one or more batch permutations includes a plurality of additional permutations of the plurality of data inputs, wherein the second set of outputs includes a set of outputs for each permutation from the first permutation, second permutation, and the plurality of additional permutations.

5. The method of claim 4, further comprising determining a confidence value for each output from the first set of outputs and the second set of outputs.

6. The method of claim 1, wherein one or more of the batch permutations includes a reduced sets of data inputs.

7. The method of claim 6, wherein the reduced sets of data inputs exclude one or more data inputs based on the one or more data inputs having associated outputs from the first set of inputs or the second set of inputs with high associated confidence values.

8. The method of claim 1, wherein generating the batch prompt output includes determining one or more weights for each output from the first set of outputs and the second set of outputs based on a confidence score determined by the large language model with respect to each output from the first set of outputs and the second set of outputs.

9. The method of claim 8, wherein the one or more weights include one or more high weight values based on the large language model determining that corresponding outputs are likely accurate, and the one or more weights include one or more low weight values based on the large language model determining that the that corresponding outputs are likely inaccurate.

10. A system, comprising:
at least one processor;
memory in electronic communication with the at least one processor;
instructions stored in the memory, the instructions being executable by the at least one processor to:
generate a batch prompt including a task input and a plurality of data inputs associated with the task input, the plurality of data inputs having a first order;
generate one or more batch permutations based on the batch prompt, each batch permutation of the one or more batch permutations including data inputs from the plurality of data inputs in a different order from the first order;
apply a large language model to the batch prompt and the one or more batch permutations to generate:
a first set of outputs responsive to the task input based on the plurality of data inputs; and
a second set of outputs responsive to the task input based on the data inputs from the plurality of data inputs of the one or more batch permutations; and
generate a batch prompt output responsive to the batch prompt, the batch prompt output including a plurality of outputs based on the first set of outputs and the second set of outputs.

11. The system of claim 10, wherein the one or more batch permutations include a first permutation of the plurality of data inputs, the first permutation including a first reordered set data inputs in which the plurality of data inputs are reordered relative to the first order.

12. The system of claim 11, wherein the one or more batch permutations include a second permutation of the plurality of data inputs, the second permutation including a second reordered set of data inputs in which the plurality of data inputs are reordered relative to the first order.

13. The system of claim 12, further comprising instructions being executable by the at least one processor to determine a confidence value for each output from the first set of outputs and the second set of outputs.

14. The system of claim 10, wherein one or more of the batch permutations includes a reduced sets of data inputs.

15. The system of claim 14, wherein the reduced sets of data inputs exclude one or more data inputs based on the one or more data inputs having associated outputs from the first set of inputs or the second set of inputs with high associated confidence values.

16. The system of claim 10, wherein generating the batch prompt output includes determining one or more weights for each output from the first set of outputs and the second set of outputs based on a confidence score determined by the large language model with respect to each output from the first set of outputs and the second set of outputs.

17. The system of claim 16, wherein the one or more weights include one or more high weight values based on the large language model determining that corresponding outputs are likely accurate, and the one or more weights include one or more low weight values based on the large language model determining that the that corresponding outputs are likely inaccurate.

18. A non-transitory computer readable medium storing instructions thereon that, when executed by at least one processor, cause a computing device to:
generate a batch prompt including a task input and a plurality of data inputs associated with the task input, the plurality of data inputs having a first order;
generate one or more batch permutations based on the batch prompt, each batch permutation of the one or more batch permutations including data inputs from the plurality of data inputs in a different order from the first order;
apply a large language model to the batch prompt and the one or more batch permutations to generate:
a first set of outputs responsive to the task input based on the plurality of data inputs; and
a second set of outputs responsive to the task input based on the data inputs from the plurality of data inputs of the one or more batch permutations; and
generate a batch prompt output responsive to the batch prompt, the batch prompt output including a plurality of outputs based on the first set of outputs and the second set of outputs.

19. The computer readable medium of claim 18, wherein the one or more batch permutations include a first permutation of the plurality of data inputs, the first permutation including a first reordered set data inputs in which the plurality of data inputs are reordered relative to the first order.

20. The computer readable medium of claim 19, wherein one or more of the batch permutations includes a reduced sets of data inputs, and wherein the reduced sets of data inputs exclude one or more data inputs based on the one or more data inputs having associated outputs from the first set of inputs or the second set of inputs with high associated confidence values.
